(19) United States
(12) Patent Application Publication
(10) Pub. No.: US 2026/0342574 A1
(43) Pub. Date: Oct. 29, 2026

(54) METHOD AND MOBILE DEVICE FOR PROVIDING A TIME READING

(71) Applicant: ASSA ABLOY AB, Stockholm (SE)

(72) Inventor: Frans Lundberg, Saltjöbaden (SE)

(21) Appl. No.: 19/119,789

(22) PCT Filed: Oct. 30, 2023
(86) PCT No.: PCT/EP2023/080247

§ 371 Date: Apr. 10, 2025

(30) Foreign Application Priority Data
Nov. 4, 2022 (SE) 2251284-2

(51) Int. Cl. H04L 9/32; G06F 1/12; G06F 1/14; G06F 21/86

(52) U.S. Cl. CPC H04L 9/3218; G06F 1/12; G06F 1/14; G06F 21/86; H04L 9/3247

(57) ABSTRACT

It is provided a method for providing a time reading. The method is performed by a mobile device (2) comprising a secure element (1) comprising a real-time clock (7). The method comprises: synchronising (40), by the secure element, the real-time clock (7) with a time server (3); letting (42) the real-time clock (7) run in the secure element (1); receiving (44), by the secure element (1), a current time request (30) from a time reader (6), via a mobile device (2); generating (46), by the secure element (1), a response, the response comprising a current time reading from the real-time clock (7), and cryptographic verification data; and sending (48), by the secure element (1), the response (32), via the mobile device (2), to the time reader (6).

### TECHNICAL FIELD

The present disclosure relates to the field of time readings, and in particular to a method and mobile device for providing a time reading to a time reader.

### BACKGROUND

It is difficult and surprisingly complicated to create a digital device that tells the correct time. Creating such a device that can tell the time in a digitally trusted way, is even harder.

Time itself is a complicated topic. There are several time scales. One follows the rotation of earth, so a particular time of day corresponds to a particular rotation angle of earth. One time scale is used in GPS (Global Positioning System) and for scientific measurements. For everyday life, however, the UTC (Coordinated Universal Time) time standard is typically used as a base for synchronising clocks. It is based TAI (International Atomic Time) which in turn is based on the time of some 500 atomic clocks, many of which use the SI (International System of Units) definition of the second to keep the time (Caesium atomic clocks). The French organization BIPM (International Bureau of Weights and Measures) publishes the UTC time based on weighing together time synchronizations of these atomic clocks.

In practice, to synchronise online computer systems, UTC time is distributed using so called NTP (Network Time Protocol) servers on the Internet. Examples of some NTP servers are found at time.google.com, ntp.se, and time.nist.gov. So, an Internet-connected server can use the UTC time standard by periodically synchronizing its internal clock with trusted NTP servers on the Internet.

Trusted clocks are important for digital security. In general, when a digital authorization is created, best practice is to have a time limit for its validity—that is, an expiry time. The access monitor (the software that takes the access granted or access denied decision), thus needs to compare the expiry time of the authorization with the current time. However, this relies on the access monitor being online to synchronise its time with trusted NTP servers. When an access monitor is an offline device, there are no good solutions in the prior art for obtaining a trusted time reading. In some cases, the access monitor is completely unpowered most of the time to save energy. How can the access monitor reliably tell the time when it needs to take an access decision? It does not have a continuous energy source, so it cannot maintain a running clock.

### SUMMARY

One object is to provide a time reading to a time reader that the time reader can validate, even when the time reader is offline.

According to a first aspect, it is provided a method for providing a time reading, the method being performed by a system comprising a time server, a mobile device comprising a secure element, and a time reader. The method comprises: synchronising a real-time clock in the secure element with the time server; letting the real-time clock run in the secure element; sending, by the time reader, a current time request to the secure element via the mobile device; receiving, by the secure element, the current time request; generating, by the secure element, a response, the response comprising a current time reading from the real-time clock, and cryptographic verification data, which comprises applying a cryptographic signature, and including, in the cryptographic verification data, proof of authentication of the secure element by the time server; sending, by the secure element, the response, via the mobile device, to the time reader; receiving, by the time reader, the response from the secure element; and verifying, by the time reader, the response based on the cryptographic verification data.

According to a second aspect, it is provided a method for providing a time reading, the method being performed by a mobile device comprising a secure element comprising a real-time clock. The method comprises: synchronising, by the secure element, the real-time clock with a time server; letting the real-time clock run in the secure element; receiving, by the secure element, a current time request from a time reader, via the mobile device; generating, by the secure element, a response, the response comprising a current time reading from the real-time clock, and cryptographic verification data, which comprises applying a cryptographic signature, and including, in the cryptographic verification data, proof of authentication of the secure element by the time server; and sending, by the secure element, the response, via the mobile device, to the time reader.

The synchronising may comprise authenticating the time server.

The time reader may be a credential reader for evaluating access to a physical space, in which case the method further comprises: interacting with the time reader using a credential stored in the mobile device, to allow the time reader to evaluate access to the physical space.

The secure element may be provided to be physically tamper-resistant.

The secure element may be provided to be physically tamper-evident.

According to a third aspect, it is provided a mobile device for providing a time reading. The mobile device comprises: a secure element comprising a real-time clock; a processor; and a memory storing instructions that, when executed by the processor, cause the mobile device to: synchronise, by the secure element, the real-time clock with a time server; let the real-time clock run in the secure element; receive, by the secure element, a current time request from a time reader, via the mobile device; generate, by the secure element, a response, the response comprising a current time reading from the real-time clock, and cryptographic verification data, which comprises applying a cryptographic signature, and including, in the cryptographic verification data, proof of authentication of the secure element by the time server; and send, by the secure element, the response, via the mobile device, to the time reader.

The instructions to synchronise comprise may comprise instructions that, when executed by the processor, cause the mobile device to authenticate the time server.

The time reader may be a credential reader for evaluating access to a physical space. In this case, the mobile device further comprises instructions that, when executed by the processor, cause the mobile device to interact with the time reader using a credential stored in the mobile device, to allow the time reader to evaluate access to the physical space.

The secure element may be provided to be physically tamper-resistant.

The secure element may be provided to be physically tamper-evident.

According to a fourth aspect, it is provided a computer program providing a time reading. The computer program comprises computer program code which, when executed on a mobile device comprising a secure element comprising a real-time clock; causes the mobile device to: synchronise, by the secure element, the real-time clock with a time server; let the real-time clock run in the secure element; receive, by the secure element, a current time request from a time reader, via the mobile device; generate, by the secure element, a response, the response comprising a current time reading from the real-time clock, and cryptographic verification data, which comprises applying a cryptographic signature, and including, in the cryptographic verification data, proof of authentication of the secure element by the time server; and send, by the secure element, the response, via the mobile device, to the time reader.

According to a fifth aspect, it is provided a computer program product comprising a computer program according to the fourth aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIG. 2 is a swim lane diagram illustrating embodiments of methods performed by the mobile device, the time reader and the time server of FIG. 1 for providing a time reading;

FIG. 3 is a schematic diagram illustrating components of the mobile device of FIG. 1 and FIG. 2; and

FIG. 4 shows one example of a computer program product 90 comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, a time reading with improved security is provided. A mobile device comprises a secure element that in turn comprises a real-time clock. The secure element is authenticated by a time server. After synchronising the real-time clock with the time server, the real-time clock can run. When a time reader (e.g. forming part of a credential reader for physical access), requests a current time via the mobile device, the secure element of the mobile device reads its real-time clock, generates cryptographic verification data, and provides this in message to the time reader.

Based on the cryptographic verification data, the time reader can verify that time server has authenticated the secure element. Notably, the mobile device 2 does not need to be trusted and only acts as a provider of communication between the secure element and the time server/time reader. Using the cryptographic verification data, the time reader can also verify that the time reading has not been tampered with after the secure element generated the message. In this solution, the time reader can be offline and still trust the time reading, as long as the time reader trusts the time server. Moreover, the mobile device can be offline at the time of the time reading, as long as there is a local communication path between the time reader and the mobile device.

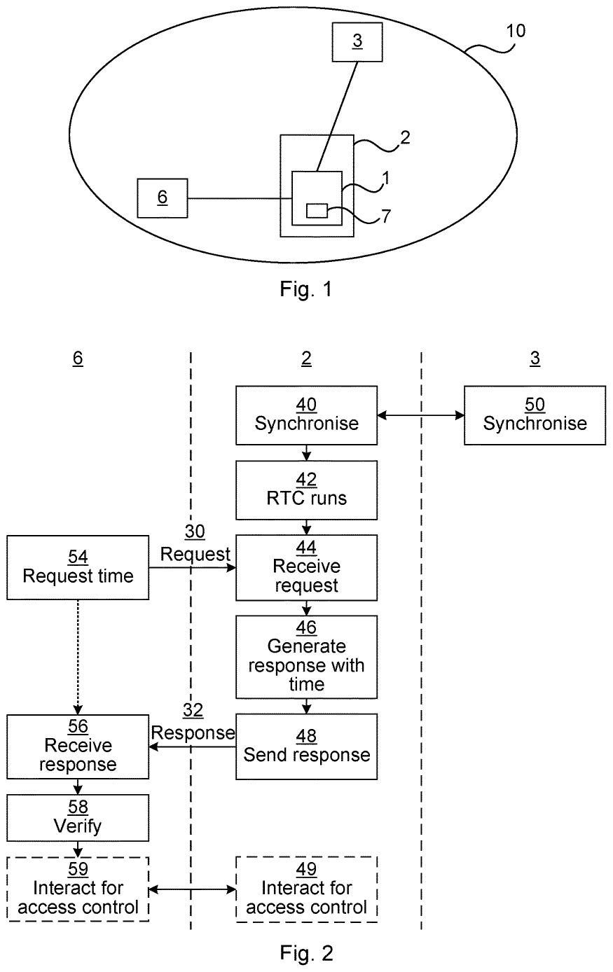

FIG. 1 is a schematic diagram illustrating an environment in which embodiments presented herein can be applied.

A time server 3 is a server that can provide an accurate time reading, e.g. in turn based on a time from an NTP server. A time reader 6 is a device that, at least occasionally, needs a time reading that it can trust. The time reader 6 may be an offline device, that cannot directly communicate with the time server 3. Furthermore, the time reader 6 can be completely off most of the time, at which point the time reader does not consume any energy. Thus, it does not and cannot maintain a running clock itself. A mobile device 2 is provided, e.g. in the form of a smartphone, wearable device (e.g. smartwatch or smart jewelry), electronic key, tablet computer, or laptop computer. Since the time reader 6 can be offline, the power consumption is limited and the time reader can thus be battery-powered or can even be powered by the mobile device, e.g. using NFC (Near-Field Communication) or a USB (Universal Serial Bus) connection. Since the time reader 6 can be powered off, it does not have a running real-time clock.

Instead, the mobile device 2 comprises a secure element 1 comprising a real-time clock 7. The secure element 1 has hardware protection to make it physically tamper-resistant. Hence, the secure element 1 is protected against attacks that attempts to manipulate the time of its real-time clock 7. For instance, the secure element 1 can be implemented such that any attempts to open an outer layer destroys the secure element, making it inoperable. This can be achieved by an adhesive to outer layers being stronger than internal connections and component integrity strength of operative parts of the secure element 1. If manipulation is detected, the clock state will be reset, and the secure element will not provide any time readings. Similarly, if the real-time clock loses power, this is detected, and the real-time clock is reset. After a reset, the real-time clock needs to be synchronised with the time server 3 before it can function again.

Optionally or additionally, the secure element 1 has hardware protection to make it physically tamper-evident. Temper-evident implies that if physical tampering is performed, this can be detected. Once tamper is detected, the secure element 1 can be reset in such a way that it will not tell the time until it is synchronised again. Alternatively, the secure element 1 is set in a permanently unusable state if physical tampering is detected.

The secure element 1 is authenticated with the time server 3. For instance, the secure element 1 can be coupled cryptographically with the time server 3 during production. This allows the time server 3 to trust the secure element 1. For instance, the secure element 1 stores the public key of time server 3, and the time server 3 stores the public key of the secure element. The public keys can form part of key pairs that are part of certificate chains, or trust can be established using secure hash values. When the time server 3 and the secure element 1 are cryptographically linked at production, the secure element and the time server can later establish secure communication with each other. Moreover, the secure element can create cryptographically signed timestamps that can be validated by any time reader.

Communication between the secure element 1 and the time server 3 can be based on a secure channel. Also, communication between the secure element 1 and the time reader 6 can be based on a secure channel. Such secure channels can be based on public keys of each end point being distributed to the other end point, as known in the art per se. The secure element 1 and the time server 3 are mutually authenticated, i.e. they trust each other. In the process described below, the time reader 6 authenticates the secure element 1. On the other hand, the secure element 1 does not need to authenticate the time reader 6, since the secure element 1 may allow an anonymous time reader 6 to ask for the current time.

As explained in more detail below, the time reader can obtain a time reading from the secure element 1 via the mobile device. The secure element responds with a time reading and verification data that proves to the time reader that the secure element 1 has been authenticated with the time server 3 and is trusted by the time server 3. In this way, the time reader 6 can obtain the current time and can trust the reading, as long as the time reader trusts the time server 3, even if the time reader 6 has never communicated with the mobile device 2 or the secure element 1 before.

Collectively, the time reader 6, the mobile device 2 comprising the secure element 1 and the time server 3 is called a system 10.

FIG. 2 is a swim lane diagram illustrating embodiments of methods performed by the mobile device 2, the time reader 6 and the time server of FIG. 1 for providing a time reading. The steps performed by the mobile device 2 form part of a method performed by the mobile device. Analogously, the steps performed by the time server 3 form part of a method performed by the time server 3 and the steps performed by the time reader 6 form part of a method performed by the time reader 6. Collectively, the steps performed by the mobile device 2 and the server 3 form part of a method performed by the system 10.

In a synchronise step 40, the mobile device 2 synchronises 40 its real-time clock 7 in the secure element 1 with the time server 3. The actions performed by the time server is represented by a corresponding synchronise step 50. The synchronising can comprise authenticating the time server 3, so that the secure element can trust the synchronisation. The authentication e.g. can be based verifying a cryptographic signature by the time server 3 or by establishing an encrypted communication channel between the secure element 1 and the time server 3. The synchronising can also comprise authenticating the secure element 1 with the time server 3. This can be based on the time server 3 previously registering a public key of the secure element 1. Alternatively, the secure element 1 is authenticated based on a certificate authority. In any case, the authentication of the secure element 1 is an indication that the time server 3 trusts the secure element 1. The authentication of the secure element 1 can be based on the time server verifying a cryptographic signature applied by the secure element 1, indicating that the secure element is in possession of a secret key that is associated with a public key that the time server 3 can verify. As part of the authentication, the time server can issue a proof of authentication of the secure element 1 by the time server 3. The proof of authentication can e.g. be a cryptographic signature by the time server 3, applied to an identification of the secure element 1. The proof of authentication can be provided to the mobile device 2.

It is to be noted that the synchronisation does not need to occur often; once a month can be sufficient. Current real-time clocks can drift less than 1.0 seconds per day.

In a RTC runs step 42, the mobile device 2 lets the real-time clock 7 to run in the secure element 1. In other words, the real-time clock continues to run after the synchronisation.

In a request time step 54, the time reader 6 sends a current time request 30 to the secure element 1 via the mobile device 2. This step is performed when the time reader 6 needs to know the current time, e.g. if the mobile device 2 is an electronic key with a validity time and the time reader 6 is an electronic lock. The current time is then needed to know if the electronic key is provided at a valid time. An attacker could try to mislead the time reader 6 with an incorrect time to e.g. make the electronic lock allow access with an expired electronic key. In such a situation, the time reader 6 should be able to trust that the time reading is correct and not manipulated.

The request can be transmitted over a secure communication channel (a secure channel or a specialized protocol based on signatures or on encryption using common secrets derived by both parties using Diffie-Hellman) between the time reader 6 and the secure channel 1.

In one embodiment, an encrypted communication channel is established between the time reader 6 and the secure element 1 to prevent data from being manipulated, e.g. by the mobile device 2.

In a receive request step 44, the mobile device 2 receives the current time request 30 (optionally over the secure communication channel). The current time request is internally routed to the secure element 1.

In a generate response with time step 46, the mobile device 2 (and more specifically the secure element 1) generates a response. The response comprises a current time reading (e.g. timestamp) from the real-time clock 7, and cryptographic verification data.

The generating the response comprises applying a cryptographic signature to data including the current time. The cryptographic signature is then (at least part of) the cryptographic verification data. The response includes, in the cryptographic verification data, proof of authentication of the secure element 1 by the time server 3, i.e. proof that the time server 3 trusts the secure element 1. The proof of authentication can e.g. be a cryptographic signature by the time server 3, applied to an identification of the secure element 1.

In a send response step 48, the mobile device 2 sends the response 32 to the time reader, optionally via the secure channel. More specifically, the secure element 1 sends the response 32, via the mobile device 2, to the time reader 6.

In a receive response step 56, the time reader 6 receives the response 32 from the mobile device 2 (originating in the secure element 1), optionally via the secure channel.

In a verify step 58, the time reader 6 verifies the response 32 based on the cryptographic verification data. For instance, when the cryptographic verification data contains a cryptographic signature, the time reader 6 can verify the cryptographic signature using a public key of the time server 3. The response can include a signature by the time server 3 that expresses that the time server 3 trusts the secure element 1. The signed data in the response can then include the public key of the secure element 1, allowing the time reader to also verify integrity of data (such as time readings) from the secure element 1. In this way, as long as the time reader trusts the time server, the time reader can also trust the secure element. Hence, the time reader can trust the current time reading just as well as if it were to come directly from the time server.

It is to be noted that there may be multiple time servers, where each secure element is associated with a time server. In this case, the time reader 6 can have multiple public keys stored, one public key for each time server. The response 32 can indicate an indication of the time server 3 with which the secure element 1 is associated, allowing the time reader to verify the cryptographic verification data using the appropriate public key.

In one embodiment, the time reader 6 is a credential reader for evaluating access to a physical space and the mobile device is an electronic key. In this case, the mobile device 2, in an optional interact for access control step 49, interacts with the time reader 6 using a credential stored in the mobile device 2, to allow the time reader to evaluate access to the physical space. There is a corresponding interact for access control step 59 at the time reader 6. When the time reader 6 grants access, an electronic lock can be unlocked, thus enabling access to the physical space.

In one embodiment, the mobile device can be in the form of an electronic key with communication ability (e.g. using a cellular modem or via local communication with a gateway device, e.g. smartphone or electronic key case). When the electronic key is first initialised, the key forwards messages between the secure element 1 and the time server 3 to synchronise the real-time clock of the secure element. When a credential reader connected to (or forming part of) the electronic key is used to unlock a lock, the credential reader is the time reader and communicates with the secure element 1 of the electronic key to get a trusted time reading. Once a trusted time reading is obtained, the credential reader can take the access decision of whether to unlock or not, e.g. by checking against validity times of the key.

Using embodiments presented herein, the time reader 6 can obtain the current time and can trust the reading, as long as the time reader trusts the time server 3. This is true even if the time reader 6 has never communicated with the mobile device 2 or the secure element 1 before. Moreover, compared to the time reader 6 obtaining a time reading from the time server on demand, via the mobile device, the time reading can occur much quicker and does not depend on the mobile device being online at that point in time. The time delay of getting a secure timestamp from a time server may be too long for many applications. For instance, consider the electronic key case where the lock should unlock without a perceived delay. Even a delay of half a second extra could significantly reduce the user experience.

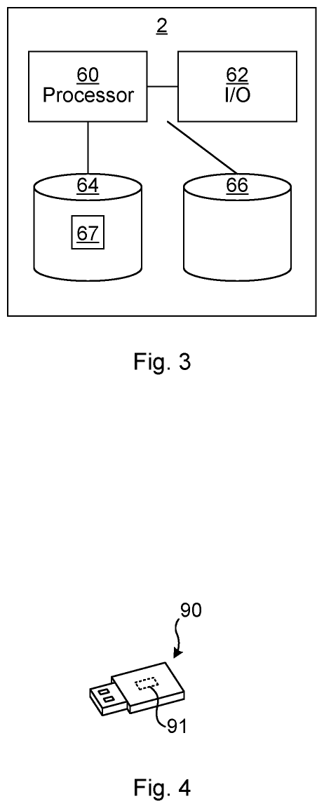

FIG. 3 is a schematic diagram illustrating components of the mobile device 2 of FIG. 1 and FIG. 2. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIG. 2 above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

An I/O interface 62 is provided for communicating with external and/or internal entities using wired communication, e.g. based on wired and/or wireless communication, e.g. local communication and/or a cellular network. The local communication can e.g. be based on Wi-Fi, Bluetooth, BLE (Bluetooth Low Energy), Ethernet, USB (Universal Serial Bus), NFC (Near-Field Communication), etc. The cellular network can comply with any one or a combination of sixth generation (6G) mobile networks, next generation mobile networks (fifth generation, 5G), LTE (Long Term Evolution), UMTS (Universal Mobile Telecommunications System) utilising W-CDMA (Wideband Code Division Multiplex), or any other current or future wireless network, as long as the principles described hereinafter are applicable.

Other components of the mobile device 2 are omitted in order not to obscure the concepts presented herein.

FIG. 4 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 3. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

Here now follows a list of embodiments from another perspective, enumerated with roman numerals.

i. A method for providing a time reading, the method being performed by a system comprising a time server, a mobile device comprising a secure element, and a time reader, the method comprising:
synchronising a real-time clock in the secure element with the time server;
letting the real-time clock run in the secure element;
sending, by the time reader, a current time request to the secure element via the mobile device;
receiving, by the secure element, the current time request;
generating, by the secure element, a response, the response comprising a current time reading from the real-time clock, and cryptographic verification data;
sending, by the secure element, the response, via the mobile device, to the time reader;
receiving, by the time reader, the response from the secure element; and
verifying, by the time reader, the response based on the cryptographic verification data.

ii. A method for providing a time reading, the method being performed by a mobile device comprising a secure element comprising a real-time clock, the method comprising:
synchronising, by the secure element, the real-time clock with a time server;
letting the real-time clock run in the secure element;
receiving, by the secure element, a current time request from a time reader, via a mobile device;
generating, by the secure element, a response, the response comprising a current time reading from the real-time clock, and cryptographic verification data; and
sending, by the secure element, the response, via the mobile device, to the time reader.

iii. The method according to embodiment ii, wherein the generating a response comprises applying a cryptographic signature.

iv. The method according to embodiment iii, wherein the generating a response comprises including, in the cryptographic verification data, proof of authentication of the secure element by the time server.

v. The method according to any one of embodiments ii to iv, wherein the synchronising comprises authenticating the time server.

vi. The method according to any one of embodiments ii to v, wherein the time reader is a credential reader for evaluating access to a physical space, and wherein the method further comprises:
interacting with the time reader using a credential stored in the mobile device, to allow the time reader to evaluate access to the physical space.

vii. The method according to any one of embodiments ii to vi, wherein the secure element is provided to be physically tamper-resistant.

viii. The method according to any one of embodiments ii to vii, wherein the secure element is provided to be physically tamper-evident.

ix. A mobile device for providing a time reading, the mobile device comprising:
a secure element comprising a real-time clock;
a processor; and
a memory storing instructions that, when executed by the processor, cause the mobile device to:
synchronise, by the secure element, the real-time clock with a time server;
let the real-time clock run in the secure element;
receiving, by the secure element, a current time request from a time reader, via a mobile device;
generating, by the secure element, a response, the response comprising a current time reading from the real-time clock, and cryptographic verification data; and
sending, by the secure element, the response, via the mobile device, to the time reader.

x. The mobile device according to embodiment ix, wherein the instructions to generate a response comprise instructions that, when executed by the processor, cause the mobile device to apply a cryptographic signature.

xi. The mobile device according to embodiment x, wherein the instructions to generate a response comprise instructions that, when executed by the processor, cause the mobile device to include, in the cryptographic verification data, proof of authentication of the secure element by the time server.

xii. The mobile device according to any one of embodiments ix to xi, wherein the instructions to synchronise comprise instructions that, when executed by the processor, cause the mobile device to authenticate the time server.

xiii. The mobile device according to any one of embodiments ix to xii, wherein the time reader is a credential reader for evaluating access to a physical space, and wherein the mobile device further comprises instructions that, when executed by the processor, cause the mobile device to interact with the time reader using a credential stored in the mobile device, to allow the time reader to evaluate access to the physical space.

xiv. The mobile device according to any one of embodiments ix to xiii, wherein the secure element is provided to be physically tamper-resistant.

xv. The mobile device according to any one of embodiments ix to xiv, wherein the secure element is provided to be physically tamper-evident.

xvi. A computer program providing a time reading, the computer program comprising computer program code which, when executed on a mobile device comprising a secure element comprising a real-time clock; causes the mobile device to:
synchronise, by the secure element, the real-time clock with a time server;
let the real-time clock run in the secure element;
receiving, by the secure element, a current time request from a time reader, via a mobile device;
generating, by the secure element, a response, the response comprising a current time reading from the real-time clock, and cryptographic verification data; and
sending, by the secure element, the response, via the mobile device, to the time reader.

xvii. A computer program product comprising a computer program according to embodiment xvi and a computer readable means comprising non-transitory memory in which the computer program is stored.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-15. (canceled)

16. A method for providing a time reading, the method being performed by a system comprising a time server, a mobile device comprising a secure element, and a time reader, the method comprising:
synchronising a real-time clock in the secure element with the time server;
letting the real-time clock run in the secure element;
sending, by the time reader, a current time request to the secure element via the mobile device;
receiving, by the secure element, the current time request;
generating, by the secure element, a response, the response comprising a current time reading from the real-time clock, and cryptographic verification data, which comprises applying a cryptographic signature, and including, in the cryptographic verification data, proof of authentication of the secure element by the time server, wherein the proof of authentication comprises a cryptographic signature by the time server, applied to an identification of the secure element;
sending, by the secure element, the response, via the mobile device, to the time reader;
receiving, by the time reader, the response from the secure element; and
verifying, by the time reader, the response based on the cryptographic verification data.

17. A method for providing a time reading, the method being performed by a mobile device comprising a secure element comprising a real-time clock, the method comprising:
synchronising, by the secure element, the real-time clock with a time server;
letting the real-time clock run in the secure element;
receiving, by the secure element, a current time request from a time reader, via the mobile device;
generating, by the secure element, a response, the response comprising a current time reading from the real-time clock, and cryptographic verification data, which comprises applying a cryptographic signature, and including, in the cryptographic verification data, proof of authentication of the secure element by the time server, wherein the proof of authentication comprises a cryptographic signature by the time server, applied to an identification of the secure element; and
sending, by the secure element, the response, via the mobile device, to the time reader.

18. The method according to claim 17, wherein the synchronising comprises authenticating the time server.

19. The method according to claim 17, wherein the time reader is a credential reader for evaluating access to a physical space, and wherein the method further comprises:
interacting with the time reader using a credential stored in the mobile device, to allow the time reader to evaluate access to the physical space.

20. The method according to claim 17, wherein the secure element is provided to be physically tamper-resistant.

21. The method according to claim 17, wherein the secure element is provided to be physically tamper-evident.

22. A mobile device for providing a time reading, the mobile device comprising:
a secure element comprising a real-time clock;
a processor; and
a memory storing instructions that, when executed by the processor, cause the mobile device to:
synchronise, by the secure element, the real-time clock with a time server;
let the real-time clock run in the secure element;
receive, by the secure element, a current time request from a time reader, via the mobile device;
generate, by the secure element, a response, the response comprising a current time reading from the real-time clock, and cryptographic verification data, which comprises applying a cryptographic signature, and including, in the cryptographic verification data, proof of authentication of the secure element by the time server, wherein the proof of authentication comprises a cryptographic signature by the time server, applied to an identification of the secure element; and
send, by the secure element, the response, via the mobile device, to the time reader.

23. The mobile device according to claim 22, wherein the instructions to synchronise comprise instructions that, when executed by the processor, cause the mobile device to authenticate the time server.

24. The mobile device according to claim 22, wherein the time reader is a credential reader for evaluating access to a physical space, and wherein the mobile device further comprises instructions that, when executed by the processor, cause the mobile device to interact with the time reader using a credential stored in the mobile device, to allow the time reader to evaluate access to the physical space.

25. The mobile device according to claim 22, wherein the secure element is provided to be physically tamper-resistant.

26. The mobile device according to claim 22, wherein the secure element is provided to be physically tamper-evident.

27. A non-transitory computer readable medium storing a computer program providing a time reading, the computer program comprising computer program code which, when executed on a mobile device comprising a secure element comprising a real-time clock; causes the mobile device to:
synchronise, by the secure element, the real-time clock with a time server;
let the real-time clock run in the secure element;
receive, by the secure element, a current time request from a time reader, via the mobile device;
generate, by the secure element, a response, the response comprising a current time reading from the real-time clock, and cryptographic verification data, which comprises applying a cryptographic signature, and including, in the cryptographic verification data, proof of authentication of the secure element by the time server, wherein the proof of authentication comprises a cryptographic signature by the time server, applied to an identification of the secure element; and
send, by the secure element, the response, via the mobile device, to the time reader.
